(19) United States
(12) Patent Application Publication
(10) Pub. No.: US 2016/0026919 A1
(43) Pub. Date: Jan. 28, 2016

(54) SYSTEM AND METHOD FOR SOCIAL EVENT DETECTION

(71) Applicant: AGT International GmbH, Zurich (CH)

(72) Inventors: Michael KAISSER, Berlin (DE); Maximilian Walther, Munich (DE); Leo Kuzmanovic, Berlin (DE)

(21) Appl. No.: 14/805,499

(22) Filed: Jul. 22, 2015

Related U.S. Application Data
(60) Provisional application No. 62/028,659, filed on Jul. 24, 2014.

(51) Int. Cl. G06N 5/04; G06N 99/00; G06F 17/30

(52) U.S. Cl. CPC G06N 5/04; G06F 17/30598; G06N 99/005

(57) ABSTRACT

A computer-implemented method, computer program product, and systems for event detection. The computer system for event detection includes an interface component configured to receive data entries from a social media data storage wherein the data entries have associated time values and location values. The received data entries are stored in a data storage component. A cluster creator of a clustering component can create a cluster with cluster data entries wherein the cluster data entries are received data entries having time values within a range of a time interval and having location values within a range of a location interval. A cluster evaluator can then determine a cluster value for the cluster by computing an event-specific cluster feature vector as input to a machine learning algorithm wherein the machine learning algorithm calculates the cluster value. If the cluster value exceeds an event detection threshold value an event is detected.

### BACKGROUND

The present invention generally relates to electronic data processing, and more particularly, relates to a methods and computer program products and systems for event detection.

For many applications detection of events is important. For example, security or safety software applications can trigger appropriate workflows to rescue people, animals or objects in the case of emergencies or disasters like, for example, fire or flooding. Besides real-world event detection systems typically making use of surveillance systems equipped with respective sensors, social media systems have been recognized as valuable information sources regarding real-world events. Social media systems enable every participant to become a local news authority and to share her own information with the whole world. As a consequence, social media is always up-to-date and has information from its users about where certain real-world events happen and when they happen.

A major challenge regarding making sense of such social media data is a very large amount of data that needs to be dealt with (big data). It is impossible to identify relevant social media posts in order to manually filter out events being interesting for a single user. The amount of data which has to be transmitted to a user and needs to be reviewed by her is not manageable by the user anymore because the data is too big and interrelated in a complex way which cannot be analyzed by the human mind.

Social media analytics has been developed to automatically analyze such data. Some prior art approaches have been developed in order to tackle the problem of social event detection. Such approaches try to re-identify already known events by using bootstrapping information from conventional news authorities. However, bootstrapping approaches typically miss a big number of events. Especially small-scale, local events cannot be captured. Other prior art approaches base their findings on the analysis of single social media posts. Due to their brevity, such posts only provide limited insights and provoke false conclusions. In addition, the data volume is not decreased noticeably since huge amounts of duplicate events are detected.

### SUMMARY

Therefore, there is a need to improve the detection of real-world events based on social media information to enable small-scale event detection in a computationally efficient manner. Aspects of the invention according to the independent claims solve this problem by providing a corresponding computer system, computer-implemented method and computer program product.

In one aspect, a computer system for event detection includes an interface component which is configured to receive data entries from a social media data storage. For example, such data entries can be received through an appropriate Social Media Application Programming Interface (API) allowing communicating with social media services such as FACEBOOK or TWITTER, FOURSQUARE or any similar service. Data entries are generated by users of the social media services and stored in the respective social media data storage. A data entry can be, for example, a tweet on TWITTER or a post on FACEBOOK. The terms data entry, tweet and post will be used as synonyms hereinafter. Such data entries generally have associated time values and location values. Further portions of such data entries can be content portions or user identification numbers (user IDs like names, nicknames, numbers, etc.) being associated with the user who creates the respective data entry. The content portion may include some information which a user wants to convey to other users of the social network. The time value may include information about the time when the user created the respective post or tweet. The location value may include information about the user's location at the time the data entry has been generated. For example, if the user creates a post or tweet on a mobile computing device (e.g., a smartphone or tablet PC), the mobile may be equipped with means to determine the user's location. Such means can include a Global Positioning Service (GPS) application or triangulation service to determine the current location of the mobile device and its user. The interface component may be configured to handle inputs from multiple social media APIs having different formats for the respective data entries.

The received data entries are then stored in a data storage component of the computer system. For example, the system may store data entries during a specific persistence time interval. The persistence time interval can be set to a couple of minutes, hours, days, or any other appropriate time interval which is suitable to store enough data entries for detecting a real-world event. The data storage component can include a database stored in a memory portion of the computer system where data entries are stored in the order they arrive. Any new data entry can be appended to the database. Data entries which stayed in the database for the duration of the persistence time interval may be deleted from the database. Deletion may depend on the relevance of the data entry for an event. In some embodiments a relational database may be used to store the data entries. However, under certain circumstances a NoSQLdatabase may be used instead by other embodiments of the invention.

The computer system further includes a clustering component. The clustering component is configured to identify data entries belonging to clusters which may be associated with a real-world event. The clustering component includes a cluster creator which can create a cluster with cluster data entries from the received data entries in the database. Criteria for creating a cluster can be that data entries have time values within a range of a time interval and have location values within a range of a location interval. In other words, a cluster may be formed by data entries which were created around a certain point in time and which originate from an area around a certain location. The term location interval can therefore be understood as a two dimensional interval, which may be defined by the radius of a circle around a specific location or as any other appropriate area shape around the specific location. For example, ten posts which were all created within one minute and which all originate from a circular area around a certain location within a radius of 100 meters may form a cluster. The clustering component further has a cluster evaluator which finally detects if the cluster data entries are associated with a real-world event or not. The cluster evaluator can calculate an event-specific cluster feature vector which is then used as input to a machine learning algorithm. The machine learning algorithm calculates a cluster value based on the feature vector by taking into account derived knowledge from the machine learning training phase and respective decision rules. A real-world event is detected if the determined cluster value exceeds an event detection threshold value. The event-specific cluster feature vector can include textual features related to content portions of the cluster data entries. It can also include quantity features related to a number associated with the cluster data entries. An example of a textual feature is a common theme appearing in multiple data cluster entries. Examples of quantity features are the number of different users associated with the cluster data entries or simply the number of data entries in a cluster. More feature examples are described in the detailed description.

The cluster evaluator can include a decision data structure configured to store decision rules for the machine learning algorithm. This decision data structure may reflect all the training data of the cluster evaluator against which the current feature vector is compared. It may further store rules according to which the machine learning takes decisions (e.g., decision trees, artificial neural network, event rules, weightings, formulas, etc.). In a way, the decision data structure provides a recipe to a machine learning classifier which is configured to apply the decision rules to the event-specific cluster feature vector.

The disclosed computer system can be seen as an event detection platform that allows generic processing of various social media sources in order to detect events of all sizes and categories without being provided with bootstrapping information. The cluster evaluator does not need to be aware of real-world events upfront but is able to identify such events even on a small scale by identifying data entries potentially indicating real-world events in respective clusters and finally making use of machine learning to verify if a respective cluster is really associated with a real-world event. Furthermore, a simple and cost-effective adaptation to specific use cases is possible to provide only relevant events to certain system operators without a need for deep technical knowledge. Furthermore, also small local events can be captured which would be likely dropped by classical news authorities for lacking importance for a big audience. This is achieved by identifying data entries that overlap in several dimensions, for example, the time they are posted, the location they are posted from, and their textual content. Other features may represent further dimensions.

The event detection platform supports real-time processing of data entries such as posts, tweets, etc. and is built around a database in which incoming data entries, intermediate results (e.g., clusters) and final results (e.g., detected events) are managed. Several independent components query and update this database as described above. Each component may be designed in a way so that multiple instances can be run in parallel.

Clustering of social media posts allows filtering out non-event-related data entries and combines remaining data entries to describe certain events. A potential consumer of these events (e.g., an operator of the event detection platform) avoids transferring the complete social media data sets from the sources to her machine or system. This massively reduces the required bandwidth while ensuring that no important data gets lost. In addition, transferred data can be limited when the consumer is only interested in certain event categories which can be detected by the machine learning component of the proposed system. Clustering in combination with machine learning allows for detecting events independent of news authorities or similar sources without a need for bootstrapping data (employing bootstrapping data is the typical prior art approach). This decreases required data input of the computer system.

In operation, the computer system constantly receives new data entries from the social media data storages. New data entries may be related to already existing clusters. Therefore, in one embodiment, the computer system may further include a cluster updater which is configured to add a further cluster data entry to the (existing) cluster when the further cluster data entry corresponds to a (new) data entry received from the social media data storage after the creation of the cluster and has a location value within the range of the location interval. That is, a new data entry, which would have been part of the cluster if it were already present at the time of cluster creation, will be just added to the existing cluster. It also may turn out after a while that two separate clusters actually refer to the same event. This can be handled by the cluster updater by merging the first cluster with a further cluster if the further cluster has a temporal and/or a spatial overlap with the first cluster and the overlap exceeds a predefined merging threshold.

In one embodiment, a data visualization component is used by the computer system to generate for an operator a visual output representing the detected event. As described before, textual and other features can be used to evaluate clusters of posts with the aim of figuring out whether they constitute a real-world event or not. Clusters scoring above a certain threshold can then be displayed in the GUI. The clustering component may include a cluster finalizer to prepare such a cluster for being displayed in the GUI. This may include enriching the cluster with additional information, such as information about the location of the detected event. Such additional information may be retrieved from other data sources, such as databases or the Internet. For example, pictures associated with the cluster data entries may be retrieved from respective data sources and added to the cluster visualization.

Further aspects of the invention will be realized and attained by means of the elements and combinations particularly depicted in the appended claims. It is to be understood that both, the foregoing general description and the following detailed description are exemplary and explanatory only and are not restrictive of the invention as described.

### BRIEF DESCRIPTION OF THE DRAWINGS

FIG. 1 illustrates a simplified system architecture of an event detection platform according to an embodiment of the invention;

FIG. 2 shows an example of event visualization for an operator of the event detection platform;

FIG. 3 illustrates an example of a graphical user interface (GUI) output for an operator of the event detection platform; and

FIG. 4 is a simplified flowchart of a computer-implemented method according to one embodiment of the invention.

### DETAILED DESCRIPTION

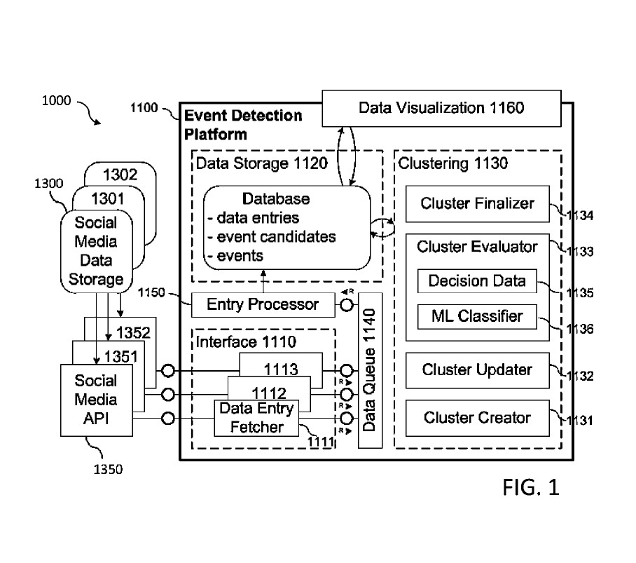

FIG. 1 is a simplified system architecture for a computer system network 1000 which includes an event detection platform 1100 for the detection of real-world events on the basis of social media data. FIG. 1 uses FMC-notation for the representation of communication paths in complex systems as known by the skilled person.

The event detection platform 1100 uses input from at least one social media service (e.g., TWITTER, FACEBOOK, etc.). In case multiple social media sources are used by the event detection platform, the event detection platform may be communicatively coupled with respective social media data storage components 1300, 1301, 1302. The data storage components 1300, 1301, 1302 are configured to track and store all kinds of information which is generated in the social media. For example, in the case of TWITTER using the first social media data storage 1300, it can include one or more storage devices for storing tweets generated by the users of the TWITTER system. Tweets are a specific embodiment of user generated data entries in general. In the case of FACEBOOK using the second social media data storage 1301, it can include one or more storage devices for storing posts generated by the users of the FACEBOOK system. Such data storage components are typically accessible via public application programming interfaces (APIs) for retrieving content from social media sites. Retrieving information through respective social media APIs 1350, 1351, and 1352 can provide current information content, such as tweets or posts, which can be retrieved in near real-time. Near real-time in this context means that the retrieval of content can occur immediately after the content has been created.

In one embodiment the event detection platform 1100 has an interface component 1110 which is configured to receive a plurality of data entries from the social media data storage component(s) 1300, 1301, 1302 through the respective APIs 1350, 1351, 1352. Typically, such data entries, like tweets or posts, comprise a content portion where the social media user is writing a message. Further, the data entries include associated time values and location values. A time value indicates the time at which the respective data entry has been generated. A location value (e.g. geo-coordinates) indicates the location of the device which was used by the user while generating the data entry.

The social media data entries are received by an interface component 1110 of the event detection platform. Because each social media API may provide the respective data entries in a different format, the interface component 110 may include multiple data entry fetchers 1111, 1112, 1113 which are adapted to the respective social media APIs 1350, 1351, 1352. Each data fetcher can therefore directly communicate with the respective social media API and import data entries from the respective social media data storage into the event detection platform.

The received data entries are then stored in a data storage component 1120. The data storage component 1120 can be an integral part of the event detection platform being communicatively coupled with the interface component 1110. In alternative embodiments data storage component(s) may be external to the platform and connected through any suitable communication network. For example, storage components can be servers in a cloud architecture and communicate with the computer system via the Internet.

In one embodiment the data entries are stored in a NoSQL (Not only SQL) database. NoSQL databases are designed for scenarios with high data volumes which is the case for social media data. Furthermore, NoSQL databases may provide advantages when querying the database, for example, for entries within a specific time interval and/or location interval. For example, some NoSQL databases support temporal and geospatial indices and are therefore well suited to store social media posts. However, other types of databases, such as relational databases, may be used as well.

In cases where the used database of the data storage component does not store the data entries in the same format as they are received by the interface component 1110, the interface component may first forward all received data entries to a data queue 1140. The data queue 1140 is configured to buffer (intermediately store) the received data entries. For example, the data queue can be implemented as a First-In-First-Out (FIFO) memory where the data entries coming in first are also leaving the data queue first. Any other appropriate buffering technology may be used instead. A data queue can be advantageous when multiple social media APIs are used which support different formats of data entries. The data entries queued up in the data queue 1140 are then processed by an entry processor 1150 which is converting the received data entries from their original format into the format supported by the used database. In other words, the entry processor is able to adjust a format of the queued data entries in compliance with format constraints of a database being part of the data storage component. From a hardware point of view, such an entry processor can also make use of a multi-core or multi-thread processor which allows parallelization of the conversion tasks. After the format conversion the data entries are stored in the database in an appropriate format for further processing.

The data storage component 1120 may have a limited storage capacity. Therefore, it can be advantageous to store data entries which were received during a specific persistence time interval. The persistence time interval can be predefined (e.g., 5 hours) or can be calculated dynamically, for example, based on the available memory size and the rate at which data entries are received in average. Other dynamic persistence time interval calculations may be used instead. Data entries being stored for a longer time than the persistence time interval may automatically be deleted.

The database of the event detection platform is communicatively coupled with a clustering component 1130. The clustering component may include sub-components, such as the cluster creator 1131 and the cluster evaluator 1133. The cluster creator 1131 can create a cluster with cluster data entries within the database. For that purpose the cluster creator analyzes the time value and the location value of the data entries in the database. For example, the time value may be a timestamp of the data entry indicating the time of creation of the data entry. The location value may correspond to the geo-coordinates which were determined by the user's device indicating the location of the device at the time of data entry creation. The cluster creator is configured to identify data entries which were created in a certain location interval (e.g., area around a specific location) during a certain time interval. The time interval may be predefined or depend on certain event types or categories (e.g., emergency events, sports events, meeting events, etc.). Temporal and geo-spatial indices can be used to execute a respective query to the database for each received data entry. For example, such a query may be: “provide all data entries which have been posted within the last 30 minutes from locations within a radius of 200 m around the location of the newly received data entry.” If the response to the query includes more hits than a predefined threshold a new cluster is created. For small scale events a threshold of three hits may already be sufficient. The identified data entries are then identified as potential event candidates. Only the time values and location values are used for cluster creation by comparing them to the respective intervals. For example, for each received data entry, the cluster creator checks whether there were more than x other data entries created during the last y minutes in a radius of z meters. Whenever a new cluster is created, it can be written to a corresponding database table storing event candidates. The following example 1 shows an example of a data structure of a created cluster with cluster ID 4. The first part (above the separation line) of the data structure may include keywords derived from the content portions of the data entries. It may further include cluster feature values calculated for the cluster as describe below. If the cluster has been evaluated already by the cluster evaluator the result may also be included. For example, the number of data entries in the cluster or the number of distinct locations. The second part (below the separation line) of the data structure includes the identified cluster data entries. Each entry may start with a unique entry identifier. Further, the location value (geo-coordinates), the user ID (username), the time value (timestamp), an optional language (e.g., “en” for English) indicator for the content portion, the content portion itself or other fields may be included.

--- example 1 ---
*** Cluster ID: 4
*** Most prominent keywords: FIRE (3) , HOBOKEN (3) ,
WASHINGTON (2)
*** Final score: 1,71, Total tweets: 4, DistinctTweeters: 3, Distinct
locations: 4, Known
bad locations: 0
-------------------------------------------------------------------------------------------
------
xxxxxxxx1816093696 40.7416,−74.0312 user1 4xxxx06 02/20/2012
00:31:06 en #Hoboken is on fire. Building above Hoboken Farm
Corporation at 300
Washington is all smoked out http://t.co/ZgjXvg
xxxxxxxx5443350530 40.7401,−74.0309 user2
2xxxxx660 02/20/2012 00:36:44 en Fire in Hoboken. 3rd and Washington.
http://t.co/rUZxT
xxxxxxxx9392819202 40.74,−74.0303 user3
1xxxxx937 02/20/2012 00:44:06 no Fire in hoboken http://t.co/CtZgE
xxxxxxxx375444480 40.7399,−74.0303 user1
1xxxxx937 02/20/2012 00:36:16 no @Hoboken411 w http://t.co/maiBg
--- end of example 1 ---

As can be seen from the timestamps of the four cluster data entries, the data entries were created within a relatively short time interval between [00:31:06, 00:44:06] on Feb. 20, 2012. They also were created within a relatively narrow location interval between [(40.7399, 74.0303), (40.7416, 74.0312)]. The cluster creator is able to recognize such data entries within narrow time and location intervals.

A cluster may have a limited life time. The life time may be predefined or dynamically determined. For example, the life time can be limited to a time interval (e.g., one day, 12 hours) which is used for all clusters. The life time may also depend on the size of the cluster, the rate at which cluster data entries come in, the distribution of cluster data entries over time, or any other appropriate measure which gives meaningful input about the ongoing relevance of the cluster for a real-world event.

After the identification of the cluster data entries for a new cluster and the following creation of the cluster (e.g., in the form of an event candidates table) the cluster evaluator 1133 computes an event-specific cluster feature vector as input to a machine learning algorithm. The event-specific cluster feature vector from the cluster evaluator 1133 is used to determine a cluster value for the cluster. The machine learning algorithm finally calculates the cluster value. For this purpose, the cluster evaluator 1133 includes a decision data structure 1135 which stores decision rules for the machine learning algorithm. Such decision rules may include rules for certain categories of events, weighting rules, or formulas which are appropriate to evaluate the cluster feature vector in view of the training data which was used to train the machine learning algorithm. Furthermore, the cluster evaluator may include a machine learning classifier 1136 which can apply the decision rules to the event-specific cluster feature vector. The cluster value calculated by the machine learning algorithm is finally compared with an event detection threshold value. Algorithms which can be used in the field of machine learning include, inter alia, for example:
artificial neural networks
genetic programming
decision tree learning
inductive logic programming
clustering
Bayesian networks
reinforcement learning
representation learning
dictionary learning
support vector machines

The event detection threshold value can be predefined or it can depend on certain parameters, such as for example, the type of the real-world event. If the cluster value exceeds the event detection threshold value the machine learning algorithm has identified a real-world event associated with the respective cluster.

Table 1 gives an overview of potential cluster features which may be part of the cluster feature vector being used as input for the machine learning algorithm. Two basic feature types are distinguished in table 1. The Textual Feature Group includes features which can be calculated primarily on the basis of the content portions of the cluster data entries. The Quantity Feature Group includes features which relate to some count values associated with the cluster data entries. The distinction between textual and quantity features is given for the purpose of illustration, there could be an overlap since some textual features include quantities, and vice versa. Those of skill in the art can group the features otherwise.

TABLE 1
Overview of potential textual and quantity features that may be used by the
system.

| | Brief Description |
|---|---|
| Textual | |
| Features | |
| Common | Calculates word overlap (or similarity) between different tweets in the |
| Theme | cluster. |
| Near | Indicates how many tweets/posts in the cluster are near-duplicates |
| Duplicates | of other tweets/posts in the cluster. |
| Positive | Indicates positive sentiment in the cluster. |
| Sentiment | |
| Negative | Indicates negative sentiment in the cluster. |
| Sentiment | |
| Overall | Indicates the overall sentiment tendency of the cluster. |
| Sentiment | |
| Sentiment | Indicates the sentiment strength of the cluster. |
| Strength | |
| Subjectivity | Indicates whether tweeters make subjective reports rather than just |
| | sharing information, e.g., links to newspaper articles. |
| Present Tense | Indicates whether tweeters talk about the here and now rather than |
| | making general statements. |
| # Ratio | Number of hash tags relative to the number of posts in the cluster. |
| @ Ratio | Number of @s relative to the number of posts in the cluster. |
| RT Ratio | Fraction of tweets/posts in the cluster that are retweets.(i.e., forwarded |
| | tweets) |
| Semantic | Indicates whether the cluster belongs to certain event categories, |
| Category | e.g., “sport event” or “fire”. |
| Quantity | |
| Features | |
| Link ratio | Indicates the number of posts that contain links. |
| Foursquare | Fraction of tweets originating from Foursquare. |
| ratio | |
| Tweet/post | Score based on how many tweets/posts are included in the cluster. |
| count | |
| Poster count | Score based on how many different users posted the tweets/posts in the |
| | cluster. |
| Unique | Score based on how many unique locations the posts are from. |
| coordinates | |
| Special | Fraction of tweets/posts that are from certain known “bad” locations, |
| location | e.g., airports or train stations. |

Table 1 has two sections. The first section relates to potential textual features and the second section relates to potential quantity-based features that may be used by the system. The first column lists the name of the feature group, the second column lists the number of features in that group, and the third column includes a brief description.

Some of the features are now explained in detail. The first part of the examples relates to the textual feature group.

Common Theme:

For each event candidate, the cluster evaluator may compute a list of the most frequent words contained in the respective content portion. For example, it may use binary term counts on data entry level. The result can be a list of words w₁ . . . wₙ and for each word the corresponding frequency f(w). A formula for computing the commonTheme feature is:

$$commonTheme ( {w}_{1} … {w}_{n} ) = \frac{1}{3 m} {\sum }_{i = 1}^{n} \{ \begin{matrix}0 & if ( {w}_{i} ) = 1 \\ f ( n ) & otherwise\end{matrix}$$

where m is the number of cluster data entries (e.g., tweets, posts, etc.) in the cluster. Alternatively, other methods can be used, for example, a method that computes the ngram overlap between the posts, instead of the word overlap.

Near-Duplicates:

The system may compute the length (len) of the longest common substring (lcs) between all pairs of cluster data entries t₁ . . . tₙ in the cluster, divide each value by the length of the respective shorter cluster data entry, and compute the mean of all quotients according to the following formula:

$$D ( {t}_{1} … {t}_{n} ) = {\sum }_{i = 1}^{n} {\sum }_{j = i + 1}^{n} \overline{\frac{len ( lcs ( {t}_{i} . {t}_{j} ) )}{min ( len ( {t}_{i} ) , len ( {t}_{j} ) )}}$$

Other near-duplicate calculation methods may used, such as for example, the shingling methods as described under http://nlp.stanford.edu/IR-book/html/htmledition/near-duplicates-and-shingling-1.html.

Sentiment Features (Positive Sentiment, Negative Sentiment, Overall Sentiment, Sentiment Strength):

Sentiment features are dictionary-based features using a selection of sentiment dictionaries to detect a cluster's sentiment. For example, the person skilled in the art may use data provided in Finnrup Nielsen: A new anew: Evaluation of a word list for sentiment analysis in “microblogs. CoRR, abs/1103.2903, 2011” and/or “Theresa Wilson, Janyce Wiebe, and Paul Homann. Recognizing contextual polarity in phrase-level sentiment analysis. In Proceedings of the conference on Human Language Technology and Empirical Methods in Natural Language Processing, HLT '05, pages 347-354, Stroudsburg, Pa., USA, 2005. Association for Computational Linguistics.” The system may also allow the creation of own dictionaries that may be manually created to include, for example, frequent emoticons. Separate scores may indicate positive or negative sentiments from the different dictionaries. Positive and negative scores may be combined into an overall sentiment score

Subjectivity:

This is another dictionary-based feature where the dictionary contains first-person personal pronouns. It is designed as an indicator as to whether social media users talk about personal experiences or about general issues.

Present Tense:

This is another dictionary-based feature where the dictionary contains common present tense verbs and auxiliaries. It can be designed as an indicator as to whether social media users talk about the “here and now” or about events in the past.

Semantic Category:

Although the machine learning algorithm is not limited to detecting real-world events from known event categories only, in practice there are categories which occur more frequently than other categories. In order to assist the machine learning algorithm in detecting these categories, one may use category-specific dictionaries that contain n-grams which are indicative for the respective category. For example, a sport events category can contain terms like “match”, “vs”, names of sport teams from a region of interest or any other sports-event-typical term. Other examples of event categories where category-specific dictionaries may be appropriate are: entertainment event, music event, traffic jam, and violence. One can define an event-specific category dictionary for any known event category.

The above listed dictionary-based textual features may follow the same or similar scoring schemes to compute the respective cluster feature value. Each dictionary entry can contain an associated weight v (where 0.0<v<1.0). This weight can be learned by the machine learning or may be manually assigned. The score for each word w in a cluster data entry t can then be computed as follows:

$$wordScore ( w ) = \{ \begin{matrix}v ( w ) & if word w is in dictionary \\ 0 & otherwise\end{matrix}$$

Based on all word scores in a cluster data entry or tweet, one can compute the cluster data entry score (also referred to as tweetScore):

$$tweetScore ( {w}_{1} … {w}_{n} ) = \frac{1}{3} {\sum }_{i = 1}^{n} wordScore ( {w}_{i} )$$

Precautions can be taken to not allow the variable tweetScore to reach a value that is larger than 1; in the simplest case one can force tweetScore to be 1 whenever its value is larger than 1.

All cluster data entries in a cluster can be combined into a cluster score. The cluster score corresponds to the cluster feature value that results from the feature vector which is used as input for the machine learning algorithm.

$$clusterScore ( {t}_{1} … {t}_{n} ) = \sqrt[2]{\frac{1}{n} {\sum }_{i = 1}^{n} tweetScore ( {t}_{i} ) )}$$

The second part of the examples relates to the quantity feature group. Quantity features may cover other relevant aspects of a cluster which cannot be retrieved from the content portion of the cluster data entries.

Tweet Count:

The tweet count indicates the number of cluster data entries in a cluster.

Poster Count:

A poster is a social media user who creates data entries. In other words, the poster of a data entry or tweet is the author of the content portion of the respective data entry. Poster count features include information about the number of posters associated with the cluster data entries in the cluster. This number may significantly deviate from the number of cluster data entries. In particular, a whole sequence of tweets from the same person may be issued at the same location. Such a monologue typically does not describe a real-world event. One poster count feature can be computed as the ratio of the amount of different posters to the data entries count in the cluster. Another poster count feature may be the absolute number of different (unique) posters in a cluster.

Unique Coordinates:

Unique coordinates features can evaluate how many cluster data entries in the cluster originate from unique coordinates. This may be useful because a cluster containing many tweets with exactly the same coordinates might indicate that they originate from bots rather than from humans. If several posters independently witness a real-world event and decide to generate respective data entries about the event, the coordinates are expected to be similar but not to be exactly the same.

Special Locations:

Social media users frequently tweet while they are bored and/or waiting. For this reason, a high number of data entries from locations like train stations and airports can be expected. For the special locations feature, a list of locations which may be associated with current or future event can be created for a respective area of interest. This cluster feature value of the special locations feature can be calculated as the fraction of cluster data entries in a cluster originating from such locations.

The following coding example illustrates for the person skilled in the art, how specific cluster feature values can be calculated by evaluating the respective cluster data entries. Example 2 shows a routine for determining the number of different/unique posters associated with a cluster in exemplary computer-language notation.

--- example 2 ---
“UniquePostersPerClusterPosts”:
private static double
computeDistinctPostersRatio(List<SentimentAnalysisPost> posts)

{double distinct =
(double) posts.Select(p => p.User.Id).Distinct( ).ToList( ).Count;

return distinct/posts.Count;}

--- end of example 2 ---

The following list of cluster feature values can be seen as the result of the cluster feature value computation for a specific cluster. Each line corresponds to an element of the example cluster feature vector which is used as input vector by the machine learning algorithm. The person skilled in the art can relate each feature to one of the above described textual or quantity features.

--- Example Feature Vector ---
Feature: semCat_Demonstration - Value: 0
Feature: semCat_Fire - Value: 0.9428
Feature: semCat_Flooding - Value: 0
Feature: semCat_GasLeak - Value: 0
Feature: semCat_MusicEvent - Value: 0
Feature: semCat_EntertainmentEvent - Value: 0
Feature: semCat_Party - Value: 0
Feature: semCat_SportEvent - Value: 0
Feature: semCat_TrafficAccident - Value: 0
Feature: semCat_TrafficJam - Value: 0
Feature: semCat_Violence - Value: 0
Feature: sentiment_EmoticonsPositive - Value: 0
Feature: sentiment_EmoticonsNegative - Value: 0
Feature: sentiment_WordsPositive - Value: 0
Feature: sentiment_WordsNegative - Value: 0
Feature: sentiment_AFINN_positive - Value: 0
Feature: sentiment_AFINN_negative - Value: 0.4
Feature: PresentTense - Value: 0.333333333333333
Feature: NoPresentTense - Value: 0
Feature: Subjectivity - Value: 0
Feature: NoSubjectivity - Value: 0
Feature: RTRatio - Value: 0
Feature: FoursquareRatio - Value: 0
Feature: CommonTheme - Value: 0.888888888888889
Feature: RatioOfLinksPerClusterTerms - Value: 0
Feature: ATRatio - Value: 0
Feature: HashtagRatio - Value: 0
Feature: NumberOfPostsPerCluster - Value: 0.3
Feature: UniquePostersPerClusterPosts - Value: 1
Feature: UniquePostersTotal - Value: 0.669701663687948
Feature: UniqueCoordinatesPerClusterPosts - Value: 1
Feature: UniqueCoordinatesTotal - Value: 0.669701663687948
Feature: SpecialLocation - Value: 0
Feature: NearDuplicates - Value: 0.159679963939599
--- end of Example Feature Vector ---

There is no need for the feature vector to include values for all features. In other words, a feature vector can also include only a subset of relevant features but still be sufficient that the machine learning algorithm can provide appropriate real-world detection results. For example, real-world detection results can already be obtained from using one of the cluster feature values or combinations of a few cluster feature values. Points a) and b) are single features which already provide meaningful results for event detection. Points c), d), and e) are combinations of features which lead to improved results and more reliable event detection compared to using a single feature. Combining even more features typically further improves such results.

a) total unique posters

b) common theme

c) total unique posters+common theme

d) total unique posters+common theme+subjectivity

e) total unique posters+common theme+subjectivity+sematic category

In other words, a cluster may be especially useful for event detection if it includes many cluster data entries from different posters (a). The more people are generating data entries from one location, the less likely it is that this data generation occurs accidentally. Therefore, the confidence that some kind of noteworthy event is happening at the location rises. Also, when people create data entries in the vicinity of the location and use the same or similar words (b), it is likely that they talk about the same thing which may be a noteworthy real-world event.

Example 3 shows the result of the evaluation of a cluster similar to the cluster shown in example 1. The machine learning algorithm computed a cluster value close to 0.8 which is exceeding the event detection threshold value (e.g., 0.6). Therefore, the clustering component detects a real-world event. In the example, the ML classifier further has classified the event with the event category: “Fire”. The event category can be derived from the classification of the various cluster data entries. Each cluster data entry may be classified or categorized according to certain classification criteria (e.g., specific key words matching an event category dictionary). If such criteria are present in a relevant percentage of cluster data entries, the whole cluster can be classified accordingly and can be assigned to a corresponding event category.

---- example 3 ----
*** Cluster ID: 2
*** Cluster Value: 0.793766535176336
*** Automatic judgment: 1
*** Automatic category: Fire
*** Most prominent keywords: HOBOKEN (3) , FIRE (3) ,
WASHINGTON (2)
-------------------------------------------------------------------------------------------
ID: xxxxxx391816093696 CreatedAt: 02/20/2012 00:31:06
UserId: user 1 Location: Coordinates(40.7416, −74.0312) Text:
#Hoboken is on fire.
Building above Hoboken Farm Corporation at 300 Washington is
all smoked out
http://t.co/ZgjXvg
ID: xxxxxx805443350530 CreatedAt: 02/20/2012 00:36:44
UserId: user 2 Location: Coordinates(40.7401, −74.0309) Text: Fire
in Hoboken. 3rd
and Washington. http://t.co/rUZxT
ID: xxxxxx659392819202 CreatedAt: 02/20/2012 00:44:06
UserId: user 3 Location: Coordinates(40.74, −74.0303) Text: Fire in
hoboken
http://t.co/CtZgE
---- end of example 3----

The event detection platform 1100 may further include a cluster updater 1132. In one embodiment the cluster updater can add a further cluster data entry to an existing cluster when the further cluster data entry corresponds to a data entry received from the social media data storage after the creation of the cluster and has a location value within the range of the location interval. In other words, even if data entries are received from the social media data storage after a cluster initially has been created, such data entries may still be associated with the event which is supposed to be associated with the created cluster. In such case it would be computationally inefficient to form a new cluster. Rather, the new data entries which stem from around the same location as the cluster data entries of the already created cluster are simply added to the existing cluster. By increasing the number of cluster data entries in a cluster even after the original creation of the cluster the quality of the respective cluster feature values can be continuously improved, thus leading to improved results of the machine learning algorithm with regards to reliability of the event detection.

In another embodiment of the cluster updater, which may be combined with the previous embodiment, the cluster updater 1132 can merge an already existing cluster with a further already existing cluster. This may be useful if the further cluster has a temporal and/or a spatial overlap with the cluster and the overlap exceeds a predefined merging threshold. This embodiment may be useful for such cases where some new received data entries had initially not been recognized as belonging to the already existing cluster and a further cluster was created. However, after a certain time both clusters may have developed in a way that a significant overlap in terms of timing and location can be identified. This may support the assumption that both clusters are related and may be associated with the same real-world event. Merging the clusters increases the number of cluster data entries which again may lead to an improvement of the cluster feature value calculation and improve the reliability of event detection.

The cluster updater may also be configured to delete a cluster if no new data entries were received for this cluster for a time interval which is long enough that it is likely that there is no current event associated with the cluster anymore. For example, if no posts or tweets were created for the last 24 hours the cluster may not be interesting anymore from an event detection perspective. The time interval for deletion may be predefined or depend on the cluster category.

The event detection platform may be operated by an operator who is supposed to initiate some action in response to an event detection, dependent on the event category. For supporting the operator in this task the event detection platform may include a data visualization component 1160 to generate for the operator a visual output representing the detected event. The visual output can be presented on any appropriate display device or on multiple display devices. The representation of a detected event may include the information from the respective cluster data entries. However, the cluster associated with the event may, for example, include links to further information related to the event. Such further information may include video or audio documents. For the operator such further information can be valuable to better assess the real-world situation at the detected event. Therefore, the clustering component 1130 may further include a cluster finalizer 1134 which can prepare the cluster for visualization by the data visualization component 1160. A cluster may become subject to enrichment with such further information if the cluster value exceeds the event detection threshold value, that is, if there is a real-world event associated with the cluster. The cluster finalizer can identify links to further information sources which may be included in the cluster data entries. For example, a poster may have taken a picture or a video of the event (e.g., a burning factory) which was uploaded to the social media data storage or elsewhere, and then include a link to the respective picture or video file in the content portion of the respective data entry. The cluster finalizer is able to parse the content portion and identify such links to complementary information sources. The additional information can be loaded into the event detection platform and stored in the data storage component 1120. For example, the database may include an events data structure which is configured to store additional information which can be retrieved based on coded parts of the content portions of the respective cluster data entries. Once the complementary information elements are stored with the respective cluster, the cluster data can be presented through the data visualization component 1160 to the operator of the system.

A cluster which is associated with a real-world event may still contain cluster data entries that are not related to the event. The machine learning setup can be robust enough to deal with this (for example, the training data may contain such examples). However, the system needs to decide about which cluster data entries should be finally displayed to the operator and in which order. In one embodiment the data visualization component 1160 can present a ranked list of documents (e.g., cluster data entries, pictures, videos, audio files, etc.) to the operator. This allows moving such cluster data entries which are effectively not associated with the real-world event towards the bottom of the ranking list. They also may be completely cut off the list. On the other hand, such cluster data entries or tweets which are representative for the whole cluster can be moved to the top of the list so that they become easily visible for the operator. The following ranking formula can be used by the cluster finalizer to perform such a ranking of cluster data entries (tweets):

$$tweetRankingScore ( {w}_{1} … {w}_{n} ) = {\sum }_{i = 1}^{n} wordCount ( {w}_{i} )$$

where wordCount(wᵢ) is a score indicating how often this word occurs in the cluster data entries (tweet) throughout the whole cluster. One may use binary tweet counts on cluster data entry (tweet) level which are summed up to a numeric score on the cluster level. All tweets in the cluster are then sorted by their TweetRankingScore and can be displayed in descending order to the operator. Such a presentation may significantly reduce the data complexity presented to the operator of the system and allow the operator to react faster for triggering actions required in the context of the detected real-world event. That is, the disclosed event detection platform is a technical tool for an operator which supports the operator in performing his/her technical tasks by reducing the data complexity to a degree where it can be further processed by the operator with mental capabilities.

Requirements for Social Media Analytics architectures generally require support for large incoming data streams that have to be processed in real-time. The event detection platform may focus on monitoring specific geographic regions only. This can be achieved by filtering the retrieved data entries by using appropriate location filters when querying the respective social medial APIs. Still, a significant number of tweets need to be stored and processed by the event detection platform. Moreover, a user may want to apply the event detection function to multiple and/or larger regions as well. The proposed architecture in FIG. 1 supports real-time processing of tweets and makes use of an appropriate database in which the received data entries are stored, and data structures corresponding to intermediate results (event candidates) and final results (detected events) are created. The various components of the clustering component 1130 can be implemented as independent sub-components which can query and update this database. A person skilled in the art can design each sub-component in a way that multiple instances can be run in parallel if necessary. As a result, the disclosed event detection platform 1100 is able to perform real-time event detection for real-world events. An advantage of the disclosed embodiments may be the ability of the platform to identify events without bootstrapping information. That is, no prior knowledge about the event is required. The system is able to create a new event even if the event is a small scale event where only a low number of posts were received by the event detection platform. It is to be noted that due to internal processing delays of any hardware used by the event detection platform, real-time event detection is always to be understood as close to real-time. Performing machine learning on the created clusters significantly reduces the amount of data because the clusters already only contain promising event candidates which are a very small set of data entries compared to the overall number of received data entries.

Bandwidth requirements may be reduced by the disclosed embodiments because non-event related posts are filtered out during the event detection process and, hence, attached systems using the platform's API only receive the most relevant data entries of the original information stream.

A further advantage of an event detection platform based on social media compared to event detection technologies based on local infrastructure at the event locations may be a higher robustness and communication reliability. When a local communication structure breaks down because of fire, earthquake or other reasons, the social network infrastructure may still be working because social media users may use mobile communication infrastructures for continuously updating the social media data storages with respective event-related data entries. In this sense, the disclosed embodiments open an additional communication channel for event detection systems.

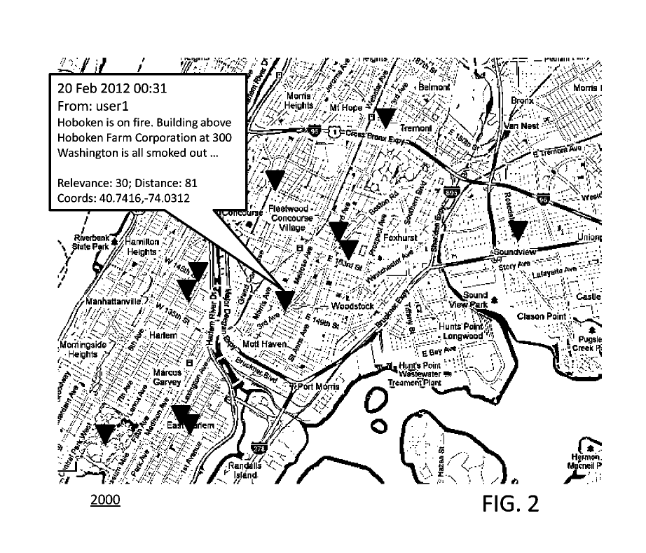

FIG. 2 shows an example of event visualization 2000 for an operator of the event detection platform. The display includes a map visualization of an area which is monitored through social media data entries. Clusters identified by the event detection platform are represented by black triangles. Any other appropriate representation can be used. The position of the triangle may correspond to the center of a circle which includes all location values of the respective cluster data entries. The clusters are associated with identified events. For example, the cluster associated with the speech bubble can include the posts as described in example 1 above related to the fire event. By clicking on anyone of the cluster representations, the operator may see the details of the respective cluster data entries.

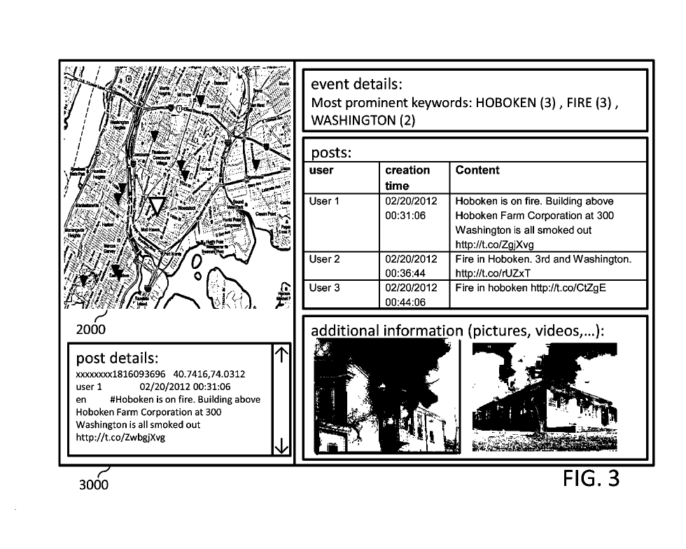

FIG. 3 illustrates an example of a graphical user interface (GUI) output 3000 of the data visualization component for an operator of the event detection platform. The GUI has different sections indicated by a respective header. In the example, the cluster finalizer has enriched the cluster information with some additional pictures in the additional information section of the GUI. The pictures may be retrieved from storage locations indicated in the links which are part of the content portion of the posts listed in the posts section of the GUI. In the example, pictures of the fire can be included for the operator to allow a better assessment of the real-world event situation. The posts section may present some details of the respective posts in a specific ranking order as previously described. For example, the posts may be ranked for the operator according to the respective TweetRankingScore. The posts section may be scrollable or paginated to allow the operator to move to other posts with a lower ranking. The GUI may also include a section with the map view 2000 described under FIG. 2. The map view may be interactive in that the operator can select a cluster representation to display all post details for the respective cluster in a post details section of the GUI. The selected representation may be highlighted (e.g., white enlarged triangle in the example). By using such a GUI, the operator is confronted with all the information that might be relevant for the detected real-world event in an interactively easy-to-use manner. The complexity of the original social media data can be significantly reduced by filtering and hiding all information which is unrelated or distractive. The event detection platform with such a reduced complexity in data visualization for the operator provides an efficient technical tool for the operator to fulfill the technical tasks of real-time event monitoring including small scale events.

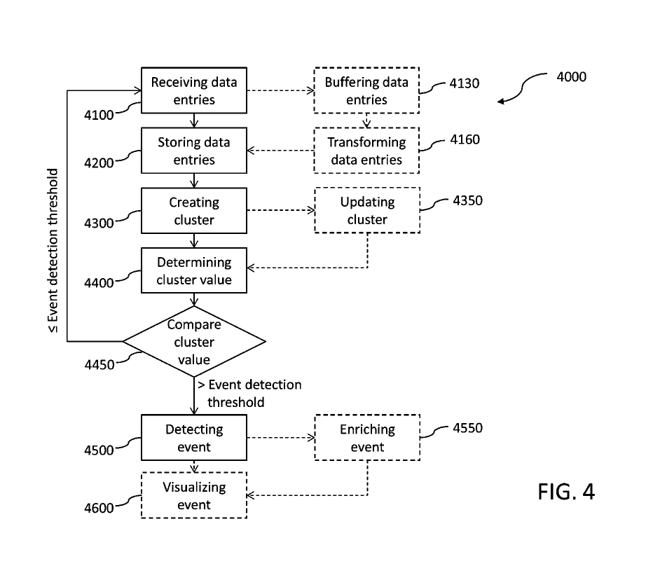

FIG. 4 is a simplified flowchart of a computer-implemented method 4000 according to one embodiment of the invention. Method steps illustrated with dashed boxes are optional. The computer-implemented method 4000 can be executed by the respective components of the event detection platform as disclosed under FIG. 1.

Initially, the event detection platform receives 4100 data entries from social media data storages. The received data entries may already be pre-filtered according to specific areas of interest to reduce the amount of posts received by the system. This helps to keep bandwidth requirements at an appropriate level.

The received data entries are stored 4200 in an appropriate database of the event detection platform. Such a database may also be remotely accessible by the event detection platform. It may support geospatial and temporal indices which allow efficient querying of the stored social media posts.

In case the received data entries have a different format compared to what is required by the database of the event detection platform, the received data entries may be buffered 4130 in an appropriate memory portion and then be transformed 4160 into a format which is required by the platform database.

The platform then creates 4300 a cluster from the stored data entries by grouping data entries which were created during a certain time interval and within a certain defined area. In other words, the system identifies cluster data entries by comparing the time values and location values of the respective data entries with cluster-specific time and location intervals. If the time and location values fall within the cluster-specific time and location intervals, the respective data entries are flagged as cluster data entries for this cluster.

If further data entries are received after the creation of the cluster, the platform may update 4350 the existing cluster with the new received data entries by adding such new received data entries to the existing cluster if there is a corresponding geospatial correspondence of the new data entries with the cluster-specific location interval. Another form of updating 4350 the cluster can be merging another cluster with the already existing cluster if both clusters have a temporal and geospatial overlap.

Based on the cluster data entries, the platform can compute textual and/or quantity cluster feature values for the cluster. The cluster feature values can be arranged in a cluster feature vector characterizing the cluster. The cluster feature vector is then used as an input for a machine learning algorithm to determine 4400 a cluster value. The cluster value is computed by the machine learning algorithm by applying decision rules and training data to the cluster feature vector.

The computed cluster value is then compared 4450 with an event detection threshold. If the cluster value exceeds the event detection threshold, an event is detected 4500 by the event detection platform. Otherwise, the platform continues with receiving data entries from the social media sources. If a cluster does not lead to an event detection, the cluster may be deleted to free up memory for other clusters.

In case a cluster is associated with a real-world event the platform can notify a platform operator of the event detection. For this purpose the platform may enrich 4550 the event data (cluster data entries) with additional information like pictures or videos which are associated with the cluster data entries.

Finally, the platform can visualize 4600 the event for the operator through standard output means, such as one or more display means. The visualization can include the enriched data if available. Otherwise, the visualization can be based on the cluster data entries.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computing device. Generally, a processor will receive instructions and data from a read-only memory or a random access memory or both. The essential elements of a computer are at least one processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Such storage devices may also provisioned on demand and be accessible through the Internet (Cloud Computing). Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having visual output devices, e.g., a cathode ray tube (CRT) or liquid crystal display (LCD) monitor, for displaying information to the user and an input device such as a keyboard, touchscreen or touchpad, a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. Client computers can also be mobile devices, such as smartphones, tablet PCs or any other handheld computing device. The components of the system can be interconnected by any form or medium of digital data communication, e.g., a communication network. Examples of communication networks include a local area network (LAN) and a wide area network (WAN), e.g., the Internet or wireless LAN or telecommunication networks.

The computing system can include clients and servers. A client and server are generally remote from each other and typically interact through a communication network. The relationship of client and server arises by virtue of computer programs miming on the respective computers and having a client-server relationship to each other.

1. A computer system for social event detection, comprising:
A computer system having:
an interface component configured to receive data entries from a social media data storage wherein the data entries have associated time values and location values;
a data storage component configured to store the received data entries;
a clustering component having:
a cluster creator configured to create a cluster with cluster data entries wherein the cluster data entries are received data entries having time values within a range of a time interval and having location values within a range of a location interval;
a cluster evaluator configured to:
determine a cluster value for the cluster by computing an event-specific cluster feature vector as input to a machine learning algorithm wherein the machine learning algorithm calculates the cluster value; and
to detect an event if the cluster value exceeds an event detection threshold value.

2. The computer system of claim 1 wherein the cluster evaluator comprises:
a decision data structure configured to store decision rules for the machine learning algorithm; and
a machine learning classifier configured to apply the decision rules to the event-specific cluster feature vector.

3. The computer system of claim 1, wherein the clustering component further has a cluster updater configured to add a further cluster data entry to the cluster wherein the further cluster data entry corresponds to a data entry received from the social media data storage after the creation of the cluster and has a location value within the range of the location interval.

4. The computer system of claim 3, wherein the cluster updater is further configured to:
merge the cluster with a further cluster if the further cluster has a temporal and/or a spatial overlap with the cluster and the overlap exceeds a predefined merging threshold.

5. The computer system of claim 1, wherein the clustering component further has a cluster
finalizer configured to prepare the cluster for visualization if the cluster value exceeds the event detection threshold value.

6. The computer system of claim 1, wherein the event-specific cluster
feature vector includes a textual feature related to content portions of the cluster data entries and/or a quantity feature related to a number associated with the cluster data entries.

7. The computer system of claim 6 wherein the quantity feature is associated with the number of different users associated with the cluster data entries.

8. The computer system of claim 1 further comprising:
a queue data structure configured to buffer the received data entries in a memory portion of the computer system; and
a data entry processor configured to adjust a format of the queued data entries in compliance with format constraints of a database which is stored in the data storage component.

9. The computer system of any one of the previous claims wherein the data storage component comprises a NoSQL database.

10. The computer system of claim 1 further comprising:
a data visualization component configured to generate a visual output representing the detected event on an output device

11. A computer implemented method for event detection comprising:
using a computer system configured to:
receive data entries from a social media data storage wherein the data entries have associated time values, location values, and content portions;
persist the received data entries during a persistence interval;
create a cluster with cluster data entries wherein the cluster includes the received data entries having time values within a range of a time interval and having location values within a range of a location interval;
determine a cluster value for the cluster by computing an event-specific cluster feature vector as input to a machine learning algorithm wherein the machine learning algorithm calculates the cluster value; and
detect an event if the cluster value exceeds an event detection threshold value.

12. The computer implemented method of claim 11, wherein the computer system is further configured to:
add an additional cluster data entry to the cluster wherein the additional cluster data entry corresponds to a data entry received from the social media data storage after the creation of the cluster and has a location value within the range of the location interval.

13. The computer implemented method of claim 12, wherein the computer system is further configured to:
merge the cluster with a further cluster if the further cluster has a temporal or a spatial overlap with the cluster and the overlap exceeds a predefined merging threshold.

14. The computer implemented method of claim 13, wherein the computer system is further configured to:
buffer the received data entries in a memory portion; and
adjust a format of the queued data entries in compliance with format constraints of a database which is stored in the data storage component.

15. The computer implemented method of claim 14, wherein the computer system is
further configured to generate for a user a visual output representing the detected event.

16. A computer program product that when loaded into a memory of a computing device and executed by at least one processor of the computing device causes the computing device to detect an event by performing a method comprising:
receiving data entries from a social media data storage wherein the data entries have associated time values, location values, and content portions;
persisting the received data entries during a persistence interval;
creating a cluster with cluster data entries wherein the cluster includes the received data entries having time values within a range of a time interval and having location values within a range of a location interval;
determining a cluster value for the cluster by computing an event-specific cluster feature vector as input to a machine learning algorithm wherein the machine learning algorithm calculates the cluster value; and
detecting an event if the cluster value exceeds an event detection threshold value.

17. The computer program product of claim 16, further comprising adding an additional cluster data entry to the cluster wherein the additional cluster data entry corresponds to a data entry received from the social media data storage after the creation of the cluster and has a location value within the range of the location interval.

18. The computer program product of claim 17, further comprising merging the cluster with a further cluster if the further cluster has a temporal or a spatial overlap with the cluster and the overlap exceeds a predefined merging threshold.

19. The computer program product of claim 18, further comprising:
buffering the received data entries in a memory portion; and
adjusting a format of the queued data entries in compliance with format constraints of a database which is stored in the data storage component.

20. The computer program product of claim 19, further comprising generating for a user a visual output representing the detected event.
